(19) United States
(12) Patent Application Publication
(10) Pub. No.: US 2002/0014454 A1
(43) Pub. Date: Feb. 7, 2002

(54) Gas- and /or liquid-permeable filter material and device and method for making the same

(76) Inventors: Rudolf Herrmann, Modling (AT); Andreas Zottl, Wiener Neudorf (AT); Gustav Jobstmann, Wien (AT)

Correspondence Address: LERNER AND GREENBERG, P.A., PATENT ATTORNEYS AND ATTORNEYS AT LAW, Post Office Box 2480, Hollywood, FL, 33022-2480, US

(21) Appl. No.: 09/922,373

(22) Filed: Aug. 3, 2001

Related U.S. Application Data
(63) Continuation of application No. PCT/AT01/00244, filed on Jul. 19, 2001.

(30) Foreign Application Priority Data
Jul. 21, 2000 (AT) 1286/2000

(51) Int. Cl. B01D 39/08

(52) U.S. Cl. 210/507

(57) ABSTRACT

Gas- and/or liquid-permeable filter material is formed from a sheetlike web material. The sheetlike web material is upset or gathered transversely to its longitudinal extent in order to form a wavy structure. A device produces a filter material of this type includes at least two profile rollers located opposite one another being disposed, as seen in the conveying direction of the sheetlike web material, downstream of at least two embossing rollers located opposite one another. The rotational speed of the embossing rollers and the profile rollers and/or the distance between the profile rollers is capable of being set for the purpose of upsetting or gathering the web material led through between the embossing and profile rollers. In addition, a method produces a filter material of this type. The sheetlike web material is upset or gathered continuously.

### CROSS-REFERENCE TO RELATED APPLICATION

This application is a continuation of copending International Application No. PCT/AT01/00244, filed Jul. 19, 2001, which designated the United States.

### BACKGROUND OF THE INVENTION

Field of the Invention

The invention relates to a gas- and/or liquid-permeable filter material made from a sheetlike web material and to a device and a method for producing a gas- and/or liquid-permeable filter material manufactured from a sheetlike web material.

Prior art filter materials are predominantly bodies that are formed from metal or ceramic and in which complicated sintering operations are necessary. Examples of when complicated sintering operation are needed are during the production of ceramic or metal foam monoliths. As a result of the complicated production process, these filter materials are often relatively costly and, moreover, have relatively low porosity.

It is known to slit metallic bands with cutting tools and stretch them perpendicularly to the slit direction, thereby producing what are known as expanded metals or stretch films. However, the open passages in these materials prevents their use as fine filters. Examples of materials not strained by such filters include pollutants, bacteria, and microbes.

European Patent Application 0 377 419 A corresponding to U.S. Pat. No. 5,071,555 shows a filter having paperlike or other sheetlike filter material which is folded to form a zigzag or accordion shape. In order to ensure that the filter material reliably has a zigzag shape in which adjacent surfaces are at a distance from one another, accumulations of adhesive, synthetic resin or the like are applied to the filter material before the folding of the latter, so that, when the filter material is folded, this has an open wedge shape in cross section.

German Published, Non-Prosecuted Patent Application DE 1 757 508 A1 discloses a filter for gas purification. The filter is made from a fabric, preferably of glass fibers or multifiber threads. The fabric is provided with an impregnation composed of hot-cured phenol resin. The filter material preferably has a corrugated or similar profile. The application does not describe in detail the way in which the filter obtains the corrugated shape.

German Published, Non-Prosecuted Patent Application DE 29 05 485 A1 shows a dimensionally stable zigzag-shaped filter structure. In the structure, a fibrous matt of brittle or friable fibers are provided with high-temperature-resistant and corrosion-resistant yarns or threads knitted in by stitch-bonding.

### SUMMARY OF THE INVENTION

It is accordingly an object of the invention to provide a gas- and/or liquid-permeable filter material and device and method for making the same that overcomes the hereinafore-mentioned disadvantages of the heretofore-known devices of this general type and that provides a filter material of the type initially mentioned. The filter material can be produced in a simple way from a sheetlike web material and can be adapted to the most diverse requirements, while at the same time it can be used, in particular, as a fine filter, in particular as a carrier material and matrix for osmosis filters or ultrafilters and also as a filler for thermal control in gases and liquids, and in catalysts, and also in explosion or fire doors.

In accordance with a further object of the invention, a device and a method are provided for producing this filter material. The purpose of the device and method are to provide a rapid and cost-effective method and a device for this purpose which allow a continuous production of the filter material.

With the foregoing and other objects in view, there is provided, in accordance with the invention, a gas- and/or liquid-permeable filter material including a sheetlike web material having a longitude. The sheetlike web material is gathered transversely to the longitude in order to form a wavy structure.

With the objects of the invention in view, there is also provided a device for producing a gas- and/or liquid-permeable filter material made from sheetlike web material. The device includes at least two embossing rollers on opposing sides of a sheetlike web material moving in a downstream direction between the at least two embossing rollers and having a rotational speed. In addition, the device includes at least two profile rollers located on the opposing sides of the sheetlike web material moving in the downstream direction between the at least two profile rollers and having a rotational speed. The at least two profile rollers are located downstream of the at least two embossing rollers. The rotational speed of the at least two embossing rollers and the rotational speed of the profile rollers is capable of being set for upsetting or gathering the sheetlike web material fed through the at least two embossing rollers and the at last two profile rollers.

With the objects of the invention in view, there is also provided a device for producing a gas- and/or liquid-permeable filter material made from sheetlike web material The device includes at least two embossing rollers on opposing sides of a sheetlike web material moving in a downstream direction between the at least two embossing rollers. The device also includes at least two profile rollers located on the opposing sides of the sheetlike web material moving in the downstream direction between the at least two profile rollers. The at least two profile rollers are located downstream of the at least two embossing rollers and have a distance between the at least two profile rollers and the at least two embossing rollers. The distance between the at least two profile rollers and the at least two embossing rollers being capable of being set for upsetting or gathering the sheetlike web material fed through the at least two embossing rollers and the at last two profile rollers.

With the objects of the invention in view, there is also provided a method for producing a gas- and/or liquid-permeable filter. The method includes providing a sheetlike web material. The next step is upsetting or gathering continuously the sheetlike web material.

The filter material according to the invention, of the type initially mentioned, includes sheetlike web material that is upset or gathered transversely to its longitudinal extent in order to form a wavy structure. The degree of gathering or upsetting of the sheetlike web material may be varied depending on the use of the filter material. Both a slight wavy shape and a structure in which adjacent waves touch one another are conceivable.

By the production of the gas - and/or liquid-permeable filter material from a sheetlike web material, a filter material is provided in a simple way. The upsetting or gathering of the sheetlike web material forms a wavy structure, has a reliable filter effect, and can be adapted to many different requirements. In particular, the material also can be used against the migration of microbes and bacteria as a fabric-friendly contact medium for living cells and for filters with large surfaces. One such application is the ultrafiltration of contaminated water. Other applications include the recycling of waste oils, the removal of hydrocarbons from water, and absorbing heat as a thermal absorber. The upset or gathered filter material also may be used as a catalyst. Such catalyst advantageously have high thermal conductivity, a low risk of overheating, a large working surface, a high catalytic capacity, and high mechanical strength. Furthermore, the upset or gathered filter material can be made very small and flexible. The material preferably used for catalysts is a rustproof steel film, the main constituents of which are 0.02% carbon, 20% chromium, 5.50% aluminum and 0.02% rare earth constituents. In particular, an aluminum fraction of between 5.5 and 7% is advantageous.

For a simple cost-effective production of the filter material, the web material preferably is a film, a woven fabric, a contexture, a knitted fabric, a mesh, a net, or a composite material. In particular, films are used that are laminated or sintered onto sheetlike porous materials, such as woven fabrics, contextures, knitted fabrics, meshes, nets, etc. The resulting composite materials have individual layers with porosity even at the commencement of the production method, wile the porosity of the films is fixed only in the subsequent method steps.

In a preferred exemplary embodiment of the filter material according to the invention, in which the sheetlike web material includes metal or ceramic, the sheetlike web material, on the one hand, advantageously has sufficient elasticity not to break during the gathering or upsetting of the web material. And, on the other hand, the web material can be penetrated in a simple way in order to acquire the desired porosity.

The porosity and therefore the gas- or liquid-permeability of the filter material can be adapted to different requirements. The porosity is adapted by including additional penetrations in the web material.

In a filter material according to the invention that has longitudinal, transverse, cruciform and/or sinusoidal penetrations in the web material, the filter effect of the filter material depends on the direction of flow of the medium to be filtered. The orientation of the passages is also important. In particular, the web material can be stretched accordingly in the longitudinal or transverse direction.

Therefore, the passages are likewise expanded according to the existing orientation.

So that the web material can be upset or gathered uniformly in a simple way and, at the same time, cracks in the web material or breaking of the web material are to be avoided, the thickness of the web material should be between 0.01 and 0.1 mm, preferably 0.03 and 0.08 mm.

The filter material may have a different thickness, as required, and it is advantageous, in particular, if the filter material has a thickness of between 1 mm and 10 mm, preferably, of 4 mm. The thickness of filter material is largely independent of the thickness of the web material, since it is dependent solely on the degree of gathering or upsetting of the web material and can therefore be fixed in a simple way during the production method.

The number of penetrations per unit area is a relevant dimension with regard to the filter effect. This number is given typically in ppi (points per inch). The filter material has a penetration density between 500 and 2000 ppi, preferably between 800 and 1600 ppi. In filter materials known already, which (as mentioned initially) are typically produced in a sintering processes, a penetration density of only about 400 ppi can be obtained. This achieves a substantially lower filter effect against very fine impurities.

So that the filter material also can be used for filtering gases or liquids that are conducted through a relatively large flow conduit, the filter material should have a width of between 200 and 600 mm, preferably of 400 mm.

For the filter material to be used for osmosis filters, the filter material needs particularly fine penetrations, with the result that a preferred exemplary embodiment of the filter material according to the invention has penetrations, the size of which is in the 10¹⁰ m range. These may be produced, for example, with the aid of an intermittent corona discharge or a pulsed plasma discharge from an electrical high voltage.

It is likewise advantageous for the filter effect if the filter material has penetrations. The size of the penetrations should be in the 10⁻⁶ m range. The penetrations can be produced with a laser.

It may also be advantageous, depending on the requirements to be met by the filter material, if the filter material has penetrations, the size of which is in the 10⁻³ m range and that can be produced, for example, by punching or with slitting knives.

Since, in a filter material having a plurality of plies of sheetlike web material, penetrations advantageously partially overlap one another, a filter material is thus provided which, in turn, has different filter properties from those of a single-ply filter material. In particular, the filter material may have two, four, eight, etc. plies of sheetlike web material, since these can be produced in a simple way by the web material being folded or turned around. Moreover, the type of gathering or upsetting of the web material also may be influenced by the thickness of the web material.

In order to connect a plurality of plies of the sheetlike web material to one another reliably, the plies of the sheetlike web material can be held together over their area with the aid of a thermally activatable lacquer.

If the sheetlike web material connects to a functional layer, the filter material can be given filter properties that the sheetlike web material alone does not possess. For example, for the filter material to be used in explosion or fire doors, an epoxy lacquer layer can serve as the functional layer.

For special applications it may also be advantageous if the filter material is connected to a functional coating, this coating being provided on the outsides, that is to say on the wave crests or troughs of the wavy structure.

For a good filter effect of the filter material that has been produced from the sheetlike web material, the sheetlike web material should have a large number of penetrations, so that the specific density of the filter material is below 5% of the specific density of the sheetlike web material.

The device according to the invention, of the type initially mentioned, is characterized in that at least two profile rollers located opposite one another are configured, as seen in the conveying direction of the sheetlike web material, downstream of at least two embossing rollers located opposite one another, and the rotational speed of the embossing rollers and of the profile rollers and/or the distance between the profile rollers can be set for the purpose of upsetting or gathering the web material led through between the embossing and profile rollers.

The sheetlike web material is drawn by the embossing rollers and is conveyed in the direction of the profile rollers, and, when the profile rollers are moved together, it butts against the profile rollers. In an extreme operating position of this type, a continuously growing material accumulation is formed between the profile and embossing rollers. When the distance between the profile rollers is increased, the upset web material can be discharged. By the setting of the draw-in speed of the web material through the embossing rollers and the setting of the draw-off speed of the web material through the profile rollers, a differential speed can be set which fixes the material buildup upstream of the profile rollers and therefore the upsetting or gathering of the web material.

So that web material of different thickness can be upset or gathered, the thickness of the web material supplied to the embossing rollers being dependent, where appropriate, only the number of folding or turning-around operations previously carried out, in a preferred exemplary embodiment of the device the distance between the embossing rollers can be set.

In order to prevent the web material to be upset from slipping back between the embossing rollers, it is advantageous if one embossing roller includes at least two embossing-roller segments and a braking roller configured between them.

So that the web material to be upset comes into contact with the braking roller only at a specific accumulation pressure, it is beneficial if the diameter of the braking roller is smaller than the diameter of the embossing-roller segments.

In order to achieve the appropriate friction between the sheetlike web material and the embossing rollers for drawing-in or for gathering, and also for reliable embossing of the web material, the embossing roller segments should be manufactured from a steel alloy.

In order to achieve an increased frictional force between the braking roller and the web material, as compared with the embossing-roller segments, the braking roller includes an elastic material, preferably a rubber compound.

So that the web material to be upset is loaded uniformly by the embossing or profile rollers, the embossing rollers and/or the profile rollers are mounted resiliently.

If the profile rollers include a plurality of profile-roller segments, the profile rollers may advantageously be adapted to different web-material widths in a modular manner.

In particular, the construction of the profile rollers can be simplified if the profile-roller segments are mounted fixedly in terms of rotation on a common shaft in order to form a profile roller.

In order to obtain a filter material that has a symmetrically upset web material, it is beneficial if holding-down devices, for example rolls, belts or the like, are provided between the embossing rollers and the profile rollers on the top side and underside of the gathered web material. The rolls, belts or the like provided as holding-down devices may also be driven for the purpose of a continuous conveyance of the web material.

So that the web material present between the embossing rollers and the profile rollers is maintained at the required fixing temperature, it is advantageous if at least one heating device is provided between the embossing rollers and the profile rollers.

In order to compensate for stress differences in the sheetlike web material, at least one pair of jockey or stress-compensating rollers is provided upstream of the embossing rollers, as seen in the conveying direction of the web material.

For very fine passages in the filter material which have a size in the range of 10⁻¹⁰ m, it is beneficial if a device for penetrating the sheetlike web material by electrical high voltage is provided upstream of the embossing rollers, as seen in the conveying direction of the web material. The electrical high voltage along with intermittent corona discharge and pulsed plasma discharge can produce very fine penetrations of the web material. Such fine penetrations are advantageous when the filter material is used as an osmosis filter.

If a heating device is provided, as seen in the conveying direction of the web material, upstream of the device for penetrating the sheetlike web material with electrical high voltage, barrier layers can be heated and activated, for example swollen, prior to the corona treatment, so that the subsequent corona treatment can give rise in a simple way to punctures through the bubbles formed.

To heat the web material in a simple way, it is beneficial if the heating device provided is infrared heating.

If the heating rate by infrared heating is insufficient, for example because the run-through speed of the web material does not allow the necessary heating in the available time or because the web material does not experience sufficient heating per unit time on account of the thermal mass inertia, the heating device should provide direct flame with a gas flame, for example Bekeart heating. The choice of heating prior to corona treatment therefore also depends on the material thickness, on the material used, and on the required penetration strength of the web material.

In order to provide penetrations in the filter material that are in the size range of 10⁻⁶ m, a laser for penetrating the web material can be provided upstream of the embossing rollers, as seen in the conveying direction of the web material.

If punching or slitting knives are provided upstream of the embossing rollers, as seen in the conveying direction of the web material, penetrations, the size of which is in the range of 10⁻³ m, can advantageously be provided in the filter material.

In order to satisfy the respective requirements to be met by the filter material, a device for fixing a functional layer can be provided upstream of the punching or slitting knives, as seen in the conveying direction of the web material. In which case, for example after corona treatment, a 20 mm thick functional barrier layer including PE-PA-PE can be fixed permanently to the sheetlike web material by carbon-dioxide (CO₂) fixing (cold shock).

In order to increase the surface and the penetrations in the sheetlike web material, a tentering frame can be provided upstream of the embossing rollers, as seen in the conveying direction of the web material.

So that a filter material with a sheetlike web material of different height can be produced, it is advantageous if a turning-around device is provided downstream of the tentering frame, as seen in the conveying direction of the web material, since the thickness of the web material can thereby be increased to twofold, fourfold, eightfold, etc. as a function of the number of turning-around operations.

So that the gathered web material can be connected to a sheetlike coating, it is beneficial if a device for introducing a functional coating to the gathered web material is provided between the embossing and profile rollers. This functional layer is therefore not deformed either by the punching and slitting knives or via the embossing rollers. The fixing of the functional coating may be carried out either by plasticizing a thermoplastic layer on the functional coating or by mechanical needling between the coating and the gathered web material, for example even with the profile rollers.

In order to provide further penetrations in the web material which, in particular, provide new passages in the web material which, where appropriate, has previously been folded and/or expanded or contracted, it may be advantageous if the embossing-roller segments have punching knives.

The method according to the invention, of the type initially mentioned, is characterized in that the sheetlike web material is upset or gathered continuously. By virtue of the continuous upsetting or gathering of the sheetlike web material, a filter material that can be adapted to different requirements can be produced in a cost-effective way.

So that the porosity of the filter material can be adapted to the respective requirements, it is advantageous if the sheetlike web material is penetrated prior to the upsetting or gathering. In particular, a reliable filter material can be obtained in the case of penetrations, the finenesses of which are in the range of 10⁻¹⁰ to 10⁻³ M.

To produce a filter material with as homogeneous filter properties as possible, irrespective of the direction of flow of the medium to be filtered, the sheetlike web material may be penetrated longitudinally, transversely, cruciformly and/or sinusoidally.

If the filter material is to be given filter properties that could not be achieved by the web material alone, it may be advantageous if a functional layer is applied to the sheetlike web material prior to upsetting or gathering. A functional layer of this type which is provided may be, for example, a 20 mm thick PE-PA-PE layer which can be connected to the web material by a cold shock, for example CO₂ fixing.

In order in a simple way to obtain a filter material of different thickness which is adapted in each case to the existing requirements, it is beneficial if the sheetlike web material is folded or turned around at least once prior to upsetting or gathering. The filter material can thus have a thickness that corresponds to twofold, fourfold, eightfold, etc. of the thickness of the web material before turning around.

In order to increase the penetrations provided in the longitudinal direction, the sheetlike web material cam be tensioned or expanded in width before folding or turning around. The degree of expansion of the web material can be set via the opening angle of the V-shaped tentering frame provided for expansion, and, in particular, an expansion up to the factor 3 may take place.

Contracting the sheetlike web material by longitudinal expansion prior to folding or turning around can stretch the penetrations, particularly those which are provided transversely to the conveying direction of the sheetlike web material.

In order to provide the gathered web material with a functional coating that is not previously penetrated, a functional coating is applied to the filter material during the upsetting or gathering.

To fix the functional coating on the gathered web material in a simple way, the functional coating can be fixed on the sheetlike web material by plasticizing a thermoplastic layer.

In order to connect the functional coating to the gathered web material without thermal treatment, the functional coating can be connected to the sheetlike web material by needling.

Other features which are considered as characteristic for the invention are set forth in the appended claims.

Although the invention is illustrated and described herein as embodied in a gas- and/or liquid-permeable filter material, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWING

FIG. 1 is a partial schematic and partial diagrammatic view of the device for producing a gas- and/or liquid-permeable filter material;

FIG. 2 shows a diagrammatic view of an embossing roller with two embossing-roller segments and a braking roller;

FIG. 3a shows a diagrammatic view of a profile roller with a plurality of modular profile-roller segments;

FIG. 3b shows a diagrammatic view of a profile roller for producing an L-shaped filter material;

FIG. 3c shows a diagrammatic view of a profile roller for producing a U-shaped filter material; and

FIG. 4 shows a diagrammatic view of a filter material with a functional coating.

### DESCRIPTION OF THE PREFERRED EMBODIMENTS

In all the figures of the drawing, sub-features and integral parts that correspond to one another bear the same reference symbol in each case.

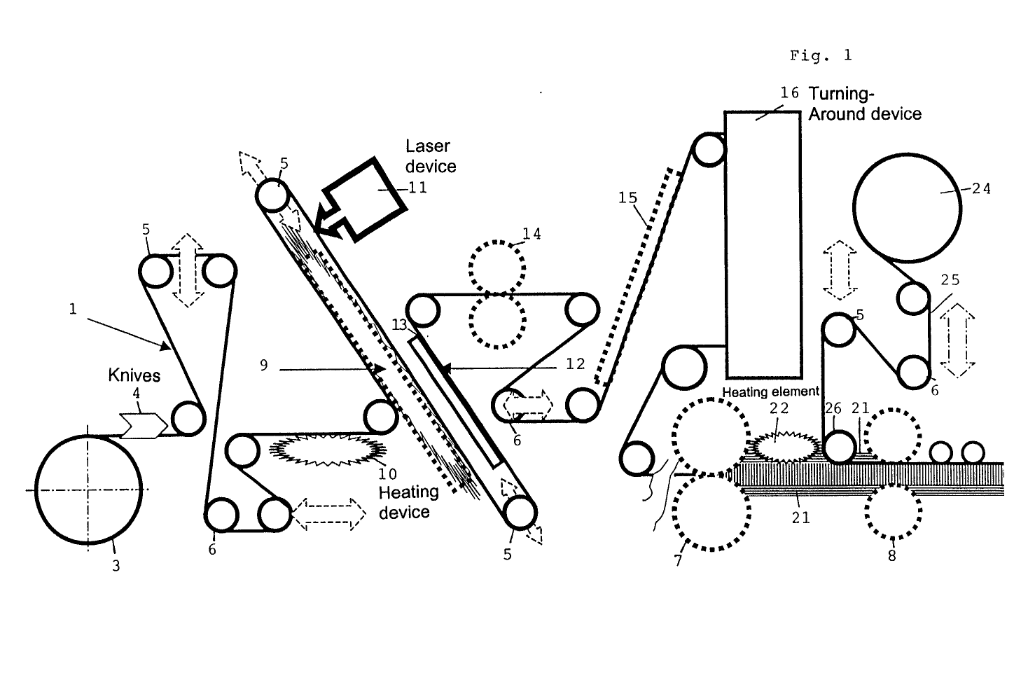

Referring now to the figures of the drawings in detail and first, particularly to FIG. 1 thereof, there is shown a filter material 2 (for details of which, see FIG. 4). The sheetlike web material 1 is drawn from a rotational-speed-variable winder 3, the rotational speed of which is synchronized with the rest of the device. The sheetlike web material 1 then is supplied to knives 4. Knives 4 are provided for edge or side trimming. The knives 4 can be heated for providing a reliable cutting force.

The sheetlike web material 1 is then guided over a plurality of jockey rollers 5 or stress-compensating rollers 6, in order to tension the sheetlike web material 1 uniformly. For this purposes, the jockey rollers 5 are vertically adjustable and the stress-compensating rollers 6 are adjustable in terms of the horizontal distance between them. The device is configured in such a way that, in every operating state, that is to say starting up, constant running, slowing down, or emergency stop, the tension of the web material 1 is within the predetermined tolerances. Between the winder 3 and a winder for receiving the filter material 2 produced (not shown), the stresses in the sheetlike web material 1 are kept constant by the jockey rollers 5 and the compensating rollers 6. This is necessary because changes in the stresses in the web material would lead to adverse effects on a uniform formation of the filter material between the embossing rollers 7 and the profile rollers 8.

Before being drawn in between the two embossing rollers 7, the sheetlike web material is penetrated. For this purpose, a device 9 is provided. The device 9 forms electrical high voltage punctures in the web material with the aid of an intermittent corona discharge and a pulsed plasma discharge to produce passages in the web material 1 that are in the size range of 10⁻¹⁰ m.

Before the web material 1 is subjected to the corona or plasma treatment, barrier layers of the web material 1 can be heated and activated, for example swollen, by a heating device 10, so that the subsequent corona or plasma treatment can cause punctures through the bubbles formed.

Since the heating rate depends on the run-through speed of the web material 1 and therefore on the available heating time, different heating devices 10 may be provided.

At lower run-through speeds, it is sufficient, for example, to have infrared heating, whereas, at higher run-through speeds, for example, direct flaming with a gas flame, for example Bekeart heating, may be provided, in order to achieve the heating of the web material 1 which is necessary within the relatively short unit of time.

Coordination between the thermal treatment and corona or plasma treatment allows the desired penetrations in the 10⁻¹⁰ m range and the reaction (foaming up or swelling) of the barrier layers. Also, the choice of heating 10 depends on the material thickness of the web material 1, on the material used and on the required penetration strength.

After the corona or plasma treatment, the web material 1 can be supplied to a laser device 11, which is intended for providing penetrations in the size range of 10⁻⁶ m in the sheetlike web material 1.

After the web material 1 has been deflected again over a jockey roller 5, a functional layer 13 can be applied to the web material 1 with a device 12 and may include, for example, of a 20 mm thick PE-PA-PE layer. In particular, to fix this functional layer 13, a cold shock via the supply of CO₂ is possible, in order to connect the functional layer 13 permanently to the sheetlike web material 1.

To use the web material 1 in fire doors (not shown), a fire-retarding two-component epoxy lacquer layer may be provided as the functional layer 13. This two-component epoxy lacquer layer foams under heat, with the result that the penetrations in the web material 1 are closed and the web material 1, which is gas-permeable without the action of heat, thus forms a heat-resistant and fire-resistant fire door. In particular, it is also beneficial, in this case, if the wavy web material is configured transversely to the throughflow direction, so that consolidation of the configuration in a frame which, if appropriate, surrounds the web material 1 occurs, since the web material 1 is stretched by the expanding epoxy lacquer layer.

The web material 1 is thereafter led through between punching or slitting knives 14 that can produce passages in the web material 1 of the order of 10⁻³ m.

To increase the specific surface of the filter material 2 to be produced, this being necessary in the case of fungicidally acting coatings, in particular for killing bacteria with silver nitrate and a copper coating, a tension device 15 is provided, including a V-shaped tentering frame that has an adjustable opening angle and that engages on the outer edge of the web material 1 with grippers, rolls or belts (not shown). The tension device 15 can expand the web material 1 continuously up to a factor of three (3×) transversely to the conveying direction of the web material 1.

It is also possible, after the penetrations have been provided, for the web material 1 to be expanded in the longitudinal direction with a higher rotational speed of the following jockey rollers 5 or stress-compensating rollers 6, thus resulting in a contraction in the width of the web material 1. This degree of contraction depends on the respective longitudinal expansion and may take place up to a factor of three (3×).

After expansion in the longitudinal or transverse direction, the web material 1 may be turned around or folded by a turning-around device 16, with the result that the width of the web material 1 is halved during each folding operation. A web material 1 can thereby be produced, the total height of which amounts, depending on the number of turning-around operations, to twofold, fourfold or eightfold the height of the web material 1 introduced into the turning-around device 16.

The web material 1 is subsequently led through the two embossing rollers 7, which may also have punching or slitting knives. The embossing rollers 7 may likewise have ultrasonic devices (not shown) that make a connection between the plies of the web material 1, which are turned around and lie one on top of the other. The fixing of the web material plies likewise may be carried out by a thermally activatable coating that cures after thermal actuation. This curing may be reversible by cooling a thermoplastic layer or irreversible in the case of a two-component lacquer layer, the layer being applied in the turning-around device 16.

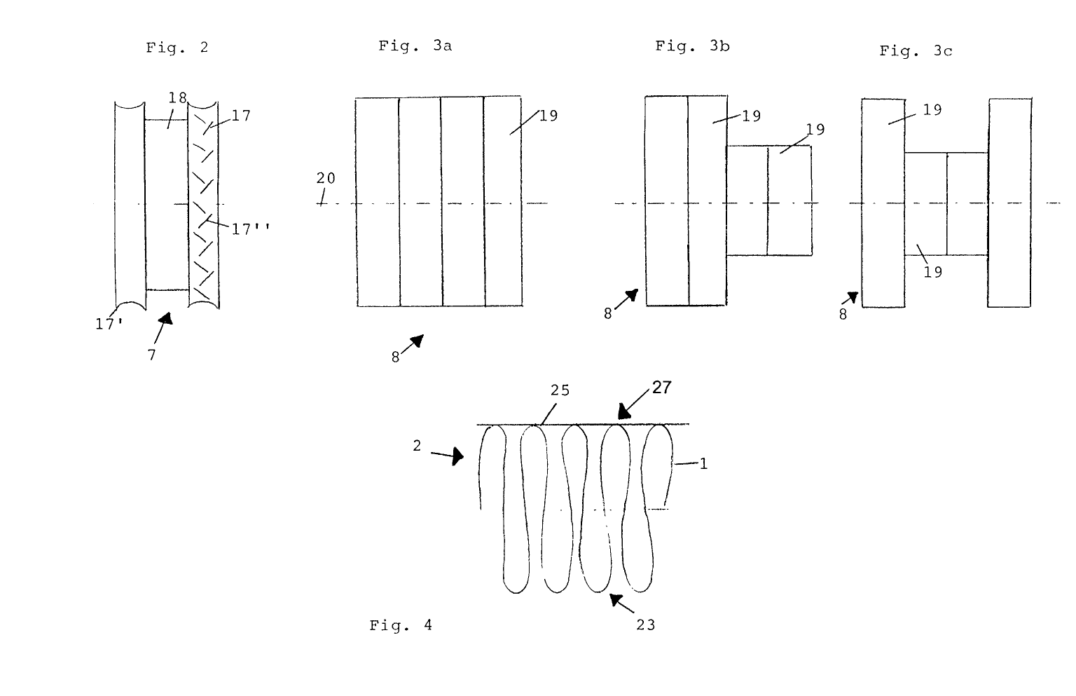

As is evident from FIG. 2, the embossing rollers 7 include at least two embossing-roller segments 17 and a braking roller 18 disposed between them. The embossing-roller segments 17 may include a steel alloy and the braking rollers 18 of a rubber compound in order to obtain the necessary friction between the web material 1 and the embossing rollers 7. As indicated in FIG. 2 with regard to one embossing-roller segment 17, the embossing-roller segments 17 may also have additional punching knives 17″ as well as the lateral cutting knife 17′.

Sprung profile rollers 8 are configured, as seen in the conveying direction of the web material 1, downstream of the embossing rollers 7, which are adjustable in terms of the distance between them. The horizontally mounted profile rollers 8 are mounted adjustably in terms of the vertical distance between them, so that the freely adjustable profile rollers 8 can be moved toward one another until said rollers make contact.

The number of profile rollers 8 depends on the width of the web material 1. The width of the individual profile rollers can be changed by the number of profile-roller segments 19 on a common drive shaft 20, as is evident from FIG. 3a. In particular, profile-roller segments 19 of different diameter (cf. FIGS. 3b and 3c) and with different profiling may also be used, so that not only filter elements of rectangular cross section can be produced, but, for example, also L-shaped or U-shaped cross sections can be produced.

Between the embossing rollers 7 and the profile rollers 8, vertically adjustable holding-down devices 21 are provided on the top side and underside of the gathered web material 1 and may also be provided with regulatable (driven or braked) rolls or transport belts. The result of this is that, when the profile rollers 8 are moved together, the web material 1 butts against the running profile rollers 8 and a continuously growing accumulation of sheetlike web material 1 is built up between the holding-down devices 21, thus resulting in a symmetrical wavy structure of upset or gathered web material 1 (cf. FIG. 4). The special shape of the wavy structure also depends on the type of material selected and on the previous penetration, expansion, turning around and embossing by the embossing rollers.

When the distance between the profile rollers 8 is increased and at the same time the advance of the profile rollers 8 is reduced, the material accumulation upstream of the profile rollers 8 is broken down in proportion to the vertical distance between the profile rollers 8. When the profile rollers 8 are moved apart in terms of the vertical distance between them, the web material 1 accumulated upstream of them is drawn through and compressed between the profile rollers 8 due to the friction of said profile rollers.

When the passage or vertical distance between the profile rollers 8 is set to the height of the free interspace between the holding-down devices 21 and at the same time the speed of 1t the profile rollers 8 is reduced, the friction of the profile rollers 8 has the effect that the web material upset upstream of the profile rollers 8 corresponds to the clear height of the holding-down devices 21.

By virtue of the continuous regulation of the draw-off speed of the web material 1 by the profile rollers 8, a differential speed which fixes the buildup of material upstream of the profile rollers 8 can be set between the embossing and the profile rollers 7, 8.

In order to maintain dimensions and tolerances, heating elements 22, for example infrared heating elements, may be provided between a holding-down device 21 and keep the web material 1 at a fixing temperature which, if appropriate, may be necessary.

The profile rollers 8 also can run opposite to the conveying direction of the web material 1. If the accumulation pressure of the upset or gathered web material 1 is higher than the friction of the profile rollers 8 running in the opposite direction, the upset web material is pressed through between the profile rollers 8. This operating state is selected when the upset web material 1 is to be fixed and stabilized between and downstream of the profile rollers 8. When the vertical distance between the profile rollers 8 and the holding-down devices 21 is increased, the web material 1 presented by the embossing rollers 7 can be worked to the selective profile thickness, with the circumferential speed of the profile rollers 8 being further reduced. By the synchronization of the embossing roller speed and the setting of the distance between the holding-down devices 21 and the profile rollers 8, the degree of upsetting or gathering of the web material 1 and therefore the production of different filter materials 2 can be set.

On one or both outsides 27, 23 (cf. FIG. 4) of the gathered web material 1, a material 25, drawn off from a winder 24 and guided over stress-compensating or jockey rollers, may be supplied between the embossing rollers 7 and the profile rollers 8, for an additional functional coating of the gathered web material 1, via an introduction roller 26 which is therefore not treated by the preceding penetration devices 9, 11, 14.

In order to make a connection between the gathered web material 1 and the sheetlike functional coating 25, either an ultrasonic tool (not shown) can cause plasticization of a thermoplastic layer on the functional coating 25 or mechanical 1u needling can be carried out between the coating 25 and the gathered web material 1 by the profile rollers 8.

The gas- and/or liquid-permeable filter material produced by this device and this method thus includes, as shown merely diagrammatically in FIG. 4, an upset or gathered web material 1 that preferably has a height of 4 mm and a width of about 360 mm. Moreover, the filter material shown in FIG. 4 has a functional coating 25 on the top side 22. The ready-made form of the filter material 1 can thereafter be fixed by a cutting or forming device illustrated in FIG. 1.

We claim:

1. A permeable filter material, comprising a sheetlike web material having a longitudinal extent, said sheetlike web material being gathered transversely to said longitude extent in order to form a wavy structure.

2. The filter material according to claim 1, wherein said sheetlike web material is a film.

3. The filter material according to claim 1, wherein said sheet-like web material is a woven fabric.

4. The filter material according to claim 1, wherein said sheetlike web material is a contexture.

5. The filter material according to claim 1, wherein said sheetlike web material is a knitted fabric.

6. The filter material according to claim 1, wherein said sheetlike web material is a mesh.

7. The filter material according to claim 1, wherein said sheetlike web material is a net.

8. The filter material according to claim 1, wherein said sheetlike web material is a composite material.

9. The filter material according to claim 1, wherein said sheetlike web material is metal.

10. The filter material according to claim 1, wherein said sheetlike web material is ceramic.

11. The filter material according to claim 1, wherein said sheetlike web material has penetrations formed therein.

12. The filter material according to claim 11, wherein said penetrations are longitudinal.

13. The filter material according to claim 11, wherein said penetrations are transverse.

14. The filter material according to claim 11, wherein said penetrations are cruciform.

15. The filter material according to claim 11, wherein said penetrations are sinusoidal.

16. The filter material according to claim 1, wherein said sheetlike web material has a thickness between 0.01 and 0.1 mm.

16. The filter material according to claim 15, wherein said sheetlike web material has a thickness between 0.03 and 0.08 mm.

17. The filter material according to one of claim 1, wherein said wavy structure has a thickness between 1 and 10 mm.

18. The filter material according to claim 17, wherein said wavy structure has a thickness of 4 mm.

19. The filter material according to one of claim 11, wherein said sheetlike web material has a penetration density between 500 and 2000 ppi.

20. The filter material according to claim 19, wherein said sheetlike web material has a penetration density between 800 and 1600 ppi.

21. The filter material according to claim 1, wherein said sheetlike web material has a width between 200 and 600 mm.

22. The filter material according to claim 21, wherein said sheetlike web material has a width of 400 mm.

23. The filter material according to claim 1, wherein said sheetlike web material has penetrations formed therein having a diameter of 10⁻¹⁰ m.

24. The filter material according to claim 1, wherein said sheetlike web material has penetrations formed therein having a diameter of 10⁻⁶.

25. The filter material according to claim 1, wherein said sheetlike web material has penetrations formed therein having a diameter of 10⁻³ m range.

26. The filter material according to claim 1, including a plurality of plies of said sheetlike web material.

27. The filter material according to claim 26, including a thermally activatable lacquer holding said plurality of plies of said sheetlike web material together.

28. The filter material according to claim 1, including a functional layer connected to said sheetlike web material.

29. The filter material according to claim 28, wherein said functional layer is an epoxy lacquer layer.

30. The filter material according to claim 1, including a functional coating connected to said sheetlike web material.

31. The filter material according to claim 1, wherein the filter material has a specific density below 5% of a specific density of said sheetlike web material.

32. A device for producing a permeable filter material made from sheetlike web material, comprising:
at least two embossing rollers on opposing sides of a sheetlike web material moving in a downstream direction between said at least two embossing rollers and having a rotational speed;
at least two profile rollers located on the opposing sides of the sheetlike web material moving in the downstream direction between said at least two profile rollers and having a rotational speed, said at least two profile rollers located downstream of said at least two embossing rollers;
the rotational speed of said at least two embossing rollers and the rotational speed of said profile rollers being capable of being set for upsetting or gathering the sheetlike web material fed through said at least two embossing rollers and said at last two profile rollers.

33. The device according to claim 32, wherein at least one of said at least two embossing rollers includes at least two embossing-roller segments and of a braking roller disposed between said at least two embossing-roller segments.

34. The device according to claim 33, wherein said at least two embossing-roller segments have a diameter and said braking roller has a diameter, said diameter of said braking roller being smaller than said diameter of said at least two embossing-roller segments.

35. The device according to claim 33, wherein said embossing-roller segments are made from a steel alloy.

36. The device according to claim 33, wherein said braking roller is made from an elastic material.

37. The device according to claim 3G, wherein said elastic material provided is a rubber compound.

38. The device according to claim 32, wherein said at least two embossing rollers are mounted resiliently.

39. The device according to claim 32, wherein said at least two profile rollers are mounted resiliently.

40. The device according to claim 32, wherein said profile rollers include a plurality of profile-roller segments.

41. The device according to claim 40, including a common shaft, said profile-roller segments mounting fixedly in terms of rotation on said common shaft.

42. The device according to claim 32, including holding-down devices provided between said at least two embossing rollers and said at least two profile rollers on both of the opposing sides of the gathered web material.

43. The device according to claim 42, wherein at least one of said holding-down devices is a roll.

44. The device according to claim 42, wherein at least one of said holding-down devices is a belt.

45. The device according to claim 32, including a heating device provided between said at least two embossing rollers and said at least two profile rollers.

46. The device according to claim 32, including a pair of jockey rollers provided upstream of said at least two embossing rollers.

47. The device according to claim 32, including a pair of stress-compensating rollers provided upstream of said at least two embossing rollers.

48. The device according to claim 32, including a device for penetrating the sheetlike web material with electrical high voltage provided upstream of said at least two embossing rollers.

49. The device according to claim 48, including a heating device provided upstream of said device for penetrating the sheetlike web material with electrical high voltage.

50. The device according to claim 49, wherein said heating device utilizes infrared heating.

51. The device according to claim 49, wherein said heating device utilizes flaming with a gas flame.

52. The device according to claim 51, wherein said heating device utilizes Bekeart heating.

53. The device according to claim 32, including a laser for penetrating the sheetlike web material provided upstream of said at least two embossing rollers.

54. The device according to claim 32, including knives provided upstream of said at least two embossing rollers.

55. The device according to claim 54, wherein said knives are punching knives.

56. The device according to claim 32, wherein said knives are slitting knives.

57. The device according to claim 54, including a device for fixing a functional layer provided upstream of said knives.

58. The device according to claim 32, including a tentering frame provided upstream of said at least two embossing rollers.

59. The device according to claim 58, including a turning-around device provided downstream of said tentering frame.

60. The device according to claim 32, including a device for introducing a functional coating to the gathered web material provided between said at least two embossing rollers and said at least two profile rollers.

61. The device according to claim 33, wherein said embossing-roller segments have punching knives.

62. A device for producing a permeable filter material made from sheetlike web material, comprising:
at least two embossing rollers on opposing sides of a sheetlike web material moving in a downstream direction between said at least two embossing rollers;
at least two profile rollers located on the opposing sides of the sheetlike web material moving in the downstream direction between said at least two profile rollers, said at least two profile rollers located downstream of said at least two embossing rollers and having a distance between said at least two profile rollers and said at least two embossing rollers;
the distance between said at least two profile rollers and said at least two embossing rollers being capable of being set for upsetting or gathering the sheetlike web material fed through said at least two embossing rollers and said at last two profile rollers.

63. The device according to claim 62, wherein the distance between said at least two embossing rollers is adjustable.

64. The device according to claim 62, wherein at least one of said at least two embossing rollers includes at least two embossing-roller segments and of a braking roller disposed between said at least two embossing-roller segments.

65. The device according to claim 64, wherein said at least two embossing-roller segments have a diameter and said braking roller has a diameter, said diameter of said braking roller being smaller than said diameter of said at least two embossing-roller segments.

66. The device according to claim 64, wherein said embossing-roller segments are made from a steel alloy.

67. The device according to claim 64, wherein said braking roller is made from an elastic material.

68. The device according to claim 67, wherein said elastic material provided is a rubber compound.

69. The device according to claim 62, wherein said at least two embossing rollers are mounted resiliently.

70. The device according to claim 62, wherein said at least two profile rollers are mounted resiliently.

71. The device according to claim 62, wherein said profile rollers include a plurality of profile-roller segments.

72. The device according to claim 71, including a common shaft, said profile-roller segments mounting fixedly in terms of rotation on said common shaft.

73. The device according to claim 62, including holding-down devices provided between said at least two embossing rollers and said at least two profile rollers on both of the opposing sides of the gathered web material.

74. The device according to claim 73, wherein at least one of said holding-down devices is a roll.

75. The device according to claim 73, wherein at least one of said holding-down devices is a belt.

76. The device according to claim 62, including a heating device provided between said at least two embossing rollers and said at least two profile rollers.

77. The device according to claim 62, including a pair of jockey rollers provided upstream of said at least two embossing rollers.

78. The device according to claim 62, including a pair of stress-compensating rollers provided upstream of said at least two embossing rollers.

79. The device according to claim 62, including a device for penetrating the sheetlike web material with electrical high voltage provided upstream of said at least two embossing rollers.

80. The device according to claim 79, including a heating device provided upstream of said device for penetrating the sheetlike web material with electrical high voltage.

81. The device according to claim 80, wherein said heating device utilizes infrared heating.

82. The device according to claim 80, wherein said heating device utilizes flaming with a gas flame.

83. The device according to claim 82, wherein said heating device utilizes Bekeart heating.

84. The device according to claim 62, including a laser for penetrating the sheetlike web material provided upstream of said at least two embossing rollers.

85. The device according to claim 62, including knives provided upstream of said at least two embossing rollers.

86. The device according to claim 85, wherein said knives are punching knives.

87. The device according to claim 62, wherein said knives are slitting knives.

88. The device according to claim 85, including a device for fixing a functional layer provided upstream of said knives.

89. The device according to claim 62, including a tentering frame provided upstream of said at least two embossing rollers.

90. The device according to claim 89, including a turning-around device provided downstream of said tentering frame.

91. The device according to claim 62, including a device for introducing a functional coating to the gathered web material provided between said at least two embossing rollers and said at least two profile rollers.

92. The device according to claim 64, wherein said embossing-roller segments have punching knives.

93. A method for producing a permeable filter, which comprises:
providing a sheetlike web material;
upset or gathering continuously the sheetlike web material.

94. The method according to claim 931 which further comprises penetrating the sheetlike web material prior to upsetting or gathering.

95. The method according to claim 94, wherein the penetrating is performed longitudinally.

96. The method according to claim 94, wherein the penetrating is performed transversely.

97. The method according to claim 94, wherein the penetrating is performed cruciformly.

98. The method according to claim 94, wherein the penetrating is performed sinusoidally.

99. The method according to claim 93, which further comprises applying a functional layer to the sheetlike web material prior to upsetting or gathering.

100. The method according to claim 99, which further comprises fixing the functional layer on the sheetlike web material by a cold shock.

101. The method according to claim 99, which further comprises folding the sheetlike web material at least once prior to upsetting or gathering.

102. The method according to claim 101, which further comprises tensioning the sheetlike web material prior to folding or turning around.

103. The method according to claim 101, which further comprises expanded in width the sheetlike web material prior to folding.

104. The method according to claim 99, which further comprises turning around the sheetlike web material at least once prior to upsetting or gathering.

105. The method according to claim 104, which further comprises tensioning the sheetlike web material prior to turning around.

106. The method according to claim 104, which further comprises expanded in width the sheetlike web material prior to turning around.

107. The method according to claim 101, which further comprises contracting by longitudinally expanding prior to folding.

108. The method according to claim 104, which further comprises contracting by longitudinally expanding prior to turning around.

109. The method according to claim 93, which further comprises applying a functional coating to the filter material during the upsetting or gathering.

110. The method according to claim 109, which further comprises fixing the functional coating on the sheetlike web material by plasticizing of a thermoplastic layer.

111. The method according to claim 109, which further comprises connecting the functional coating to the sheetlike web material by needling.
